(19) United States
(12) Patent Application Publication
(10) Pub. No.: US 2026/0258292 A1
(43) Pub. Date: Sep. 3, 2026

(54) Flux Compatible Heat Transfer Media

(71) Applicant: CCI North America Corporation, Lemon, IL (US)

(72) Inventors: Timo Weide, Lockport, IL (US); Aleksei Gershun, Glenview, IL (US); Raul Gonzalez, Chicago, IL (US)

(21) Appl. No.: 19/155,666

(22) PCT Filed: Feb. 24, 2023
(86) PCT No.: PCT/IB2023/000098

§ 371 Date: Aug. 12, 2025

(51) Int. Cl. C09K 5/20; C09K 5/10; C23F 11/12; C23F 11/18

(52) U.S. Cl. CPC C09K 5/20; C09K 5/10; C23F 11/12; C23F 11/182

(57) ABSTRACT

An improved formula for coolants resists precipitation of the silicates due to interaction with flux residue contains of 2-[Methoxy (polyethyleneoxy)propyl] trimethoxysilane or reagents with similar structure and polarity. These silanes are used as additives to reduce or prevent precipitation in systems made from aluminum or aluminum alloys.

### CROSS-REFERENCE TO PRIOR APPLICATIONS

This is a national stage application filed under 37 U.S.C. 371 based on International Patent Application No. PCT/IB2023/000098, filed on 23 Feb. 2023.

### U.S. GOVERNMENT SUPPORT

N/A

### BACKGROUND OF THE INVENTION

### Area of the Art

The invention relates to the use of novel ionic and non-ionic reagents as additives and corrosion inhibitors for heat transfer media with conventional and low conductivity requirements in cooling systems to improve performance and to increase overall stability and/or to reduce precipitation of general formulation ingredients, particularly in formulations containing organic and inorganic silicates.

### Description of the Background Art

The use of coolants (heat transfer media) in various cooling systems that have closed cooling circuits, such as heat exchangers systems in gas, gasoline and diesel engines is wide spread and of great importance. Such cooling systems and their cooling system components can be constructed with several different metals. In many cases, aluminum and aluminum alloys are used because they have good mechanical properties, good thermal conduction, good thermal resistance even at higher temperatures and are comparatively light and readily available.

In the manufacture of cooling systems and their subcomponents (radiators, heater cores and so on), individual components and/or part of the components are often assembled via a soldering process. For soldering aluminum and aluminum alloys, fluxes are used to dissolve existing oxide layers on the metal surfaces. Fluoride and/or chloride-containing fluxes are commonly used. U.S. Pat. No. 2,179,258 provides a fundamental disclosure of such fluxes. One example of a suitable conventional flux for aluminum consists of potassium fluoride, potassium aluminum fluoride, zinc chloride, lithium chloride, sodium chloride and potassium chloride. After the removal of the oxide layer at elevated temperature under vacuum, the actual soldering process takes place. However, flux residues remain on the surfaces of cooling system components after the soldering process is complete. For cost reasons, removal of these residues by sufficient cleaning or flushing of the finished cooling system components is only rarely performed.

Leaving the flux residues in the cooling system leads to undesirable coolant deterioration. The coolant's corrosion inhibitors, including but not limited to silicate corrosion inhibitors, may react with the flux residues and in some cases may result in precipitation of the corrosion inhibitors, resulting in corrosion because the inhibitors are no longer available.

Silicate-based formulations prevent corrosion by creating a silicate layer on the aluminum surfaces. Alkaline metal silicates have proven to be particularly effective corrosion inhibitors for aluminum components when added to the coolants. It is assumed that silicates form a continuous, monomolecular, protective layer on the metal surface. However, silicates tend to fail in the presence of flux residues and to irreversibly form gel-like precipitates through polymerization reactions. These precipitates result in clogged cooler lamellae, so that the heat transfer into the coolant fluid is impeded and may lead to engine overheating and/or water pump damage and/or other general engine failures. As results of coolant interaction with flux residues the silicate content in the coolant drops significantly (levels of silicates of 30 ppm or lower are inadequate to prevent corrosion). Because the automotive and heavy-duty engine industry is continuously changing and the number of aluminum components in cooling systems has constantly increased in recent years in different ICE (internal combustion engines), BEV (battery electric vehicles) and FC (fuel cell) applications, the demand for heat transfer media with flux-compatible, silicate stabilized, organic acid, ionic and non-ionic, conventional, and low conductivity-based technology/formulations are constantly increasing as well (see, for example EP 2 586 843 A1, WO 2017/080542 A1, US 2014/0224193 A1).

To accommodate those requirements, thermal stabilized silicates, such as ortho- or metasilicates (e.g., sodium metasilicate) are typically used. Suitable silicates are those of the type:

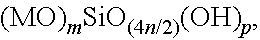

in which
M is a monovalent cation from the group of lithium, sodium, potassium, rubidium, or tetra-organo-ammonium;
m is from 1 to 4,
n is from 1 to 4 and
p is from 0 to 3, with m+p=n.

Alkaline metal metasilicates or waterglass solutions can be used. Examples include potassium metasilicate, sodium orthosilicate, potassium disilicate, sodium metasilicate, potassium metasilicate, lithium metasilicate, lithium orthosilicate, rubidium disilicate, rubidium tetrasilicate, mixed salts, tetramethyl ammonium silicate, tetra ethyl ammonium silicate, ammonium silicate, tetra hydroxyethyl ammonium silicate.

Also suitable are organic silicate esters of the type:

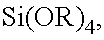

R can be an alkyl-, aryl-, or hydroxyalkyl group between C₁ and C₃₆.

Examples include organosilanes such as Silquest® Y-5560 or Silan AF-1 from Momentive, Geniosil® GF 20 from Wacker Chemie, sodium-(trihydroxysilyl)-propymethylphosphonate such as Xiameter® Q1-6083 from DOW, alkaline metal aminophosphonates, organic phosphosilicones of the type:

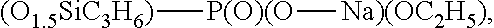

as described in U.S. Pat. Nos. 4,629,602, 4,333,843, 5,651,916, EP 0 769 573 B1, EP 0 739 966 A1, are used as silicate stabilizer.

An object of the present invention was therefore to develop a coolant concentrate, and a finished coolant based on the concentrate, which eliminates or reduces silicate corrosion inhibitor precipitation by the flux residues from soldering still present in the cooling system.

### SUMMARY OF THE INVENTION

The precipitation of the silicates due to interaction with flux or flux residue can be reduced or eliminated by addition of 2-[Methoxy (polyethyleneoxy)propyl]trimethoxysilane or reagents with similar structure and polarity to the coolant or coolant concentrate. In a preferred embodiment, 2-[Methoxy (polyethyleneoxy)propyl]trimethoxysilane is used as an additive to coolant concentrates and coolants, particularly coolant concentrates and coolants containing silicate ionic and non-ionic corrosion inhibitors, to reduce or prevent precipitation, in particular silicate precipitation, in cooling systems, in particular in coolant systems made of aluminum or aluminum alloys with residual amounts of flux or flux residue present on the cooling system components.

It was found that 2-[Methoxy (polyethyleneoxy)propyl]trimethoxysilane or reagents with similar structure and polarity can be used as a silicate stabilizer for a stabilized non-ionic silicate package which can, in particular, be used in low conductivity coolants with a conductivity range from 0-200 μS/cm showing excellent corrosion performance and flux stability/compatibility in BEV and FC coolant applications.

It was also found that high conductivity standard ICE-coolants (>3500 μS/cm) formulated with corrosion inhibitors based and aliphatic- and aromatic mono-, di-, and tricarboxylic acids and inorganic corrosion inhibitors like phosphate, organic and/or inorganic silicate, and nitrate can be reformulated to low conductivity coolants with a conductivity of less than 2000 μS/cm when their alkali- and earth alkali metal cations are replaced with ammonium salts and a stabilized non-ionic silicate is used.

In the case of the silicates contained in the coolants and coolant concentrates as corrosion inhibitors, hereinafter also referred to as “silicate corrosion inhibitors,” which form precipitates during interaction with the fluoride and chloride-containing fluxes, hereinafter also referred to as “silicate precipitations,” the silicates are water-soluble inorganic silicates or organic silanes which hydrolyze to inorganic silicates, such as alkali metal orthosilicates and/or alkali metal metasilicates. Inorganic silicates follow the general reduced formula:

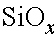

and can be ionic or neutral, polymeric, or non-polymeric. Typical examples are sodium and potassium orthosilicates as well as sodium and potassium metasilicates or “water glasses.” The inorganic silicates can also include metal oxides that are alkaline upon dissolution in water, and which aid in the dissolution of the inorganic silicates. The weight ratio of the metal oxide to the inorganic silicate is generally from about 2:1 to about 1:5, preferably from about 1:1 to about 1:3.5. Non-limiting examples of metal oxides that are alkaline upon dissolution in water include alkali metal oxides such as Na₂O and K₂O, alkaline earth metal oxides such as MgO and CaO, and the like, as well as combinations thereof.

Furthermore, various additives can be included in the concentrate, which, depending on the type, improve the properties of the coolant produced from it and protect the coolant system from corrosion. In addition to an antifreeze agent, the coolant or coolant concentrate can additionally contain one or several aliphatic, cycloaliphatic, or aromatic monocarboxylic acid(s) having 3 to 16 carbon atoms each in the form of their alkali metal, ammonium or substituted ammonium salts, one or more aliphatic, cycloaliphatic, or aromatic di- or tricarboxylic acid(s) each containing 3 to 21 carbon atoms in the form of their alkali metal, ammonium or substituted ammonium salts, non-ferrous metal inhibitors, borates (such as sodium tetraborate [borax]), benzoates, molybdates (such as sodium molybdate), nitrates (such as sodium nitrate), aliphatic, cycloaliphatic or aromatic amines with 2 to 15, preferably 4 to 8 carbon atoms, phosphates (such as di-sodium hydrogen phosphate, tri-sodium phosphate), and mixtures thereof.

Typically, according to the invention usable antifreeze agents are alcohols having, but not limited, to 1 to 3 hydroxyl groups and their water-soluble derivatives. These are, but not limited to, monohydric alcohols, diols, triols and mono-C₁-C₄ alkyl ethers of diols and triols. Examples are 1- or 2-propanol, mono-, di-, tri- or tetraethylene glycol, mono-, di-, tri- or tetrapropylene glycol or the water-miscible mono-C₁-C₄ alkyl ethers of the diols, triols, or glycerin. Particularly preferably, the antifreeze agent is selected from the group consisting of monoethylene glycol, monopropylene glycol (1,2-propanediol), 1,3-propandiol, 1,4-butandiol, glycerol, diethylene glycol, triethylene glycol, and mixtures thereof. Linear or branched chain aliphatic or cycloaliphatic monocarboxylic acids can be used; examples include propionic acid, valeric acid, hexanoic acid, cyclohexyl acetic acid, octanoic acid, 2-ethylhexanoic acid, nonanoic acid, isononanoic acid, decanoic acid, isodecanoic acid, neodecanoic acid, undecanoic acid or dodecanoic acid. The aromatic monocarboxylic acid benzoic acid is particularly suitable; in addition, for example, C₁ to C₈ alkylbenzoic acids such as o-, m-, p-methylbenzoic acid or p-tert-butylbenzoic acid and hydroxyl group-containing aromatic monocarboxylic acids such as o-, m-, or p-hydroxybenzoic acid, o-, m- or p-(hydroxymethyl)benzoic acid or halobenzoic acids such as o-, m-, or p-fluorobenzoic acid are suitable.

Typical examples of useful di- or tricarboxylic acids are malonic acid, succinic acid, glutaric acid, adipic acid, pimelic acid, suberic acid, azelaic acid, sebacic acid, undecanedioic acid, dodecanedioic acid, cyclohexane-dicarboxylic acids, phthalic acid, terephthalic acid and triazine triiminocarboxylic acids such as 6,6′,6″-(1,3,5-triazine-2,4,6-triyltriimino)-trihexanoic acid.

Carboxylic acids are used as alkali metal salts, especially as sodium or potassium salts, or as ammonium salts or substituted ammonium salts (amine salts), e.g., with ammonia, trialkylamines, wherein the alkyl groups can independently of each other contain 1 to 6, preferably 1 to 3 carbon atoms, or trialkanolamines, wherein the alkanol groups independently of each other may contain 2 to 6, preferably 2 or 3 carbon atoms.

Preferred non-ferrous metal protection agents are water-soluble azoles and their alkali metal salts, but not limited to, their, sodium salts, preferably triazoles, in particular tolyltriazole, benzotriazole, hydrogenated tolyltriazole, 1H-1,2,4-triazole, benzimidazole, benzthiazole, adenine, purine, 6-methoxypurine, indole, isoindole, pyridine, pyrimidine, 3,4-diaminopyridine, 2-aminopyrimide, 2-Mercaptopyrimidine and Mercaptobenzothiazole and their derivatives. Typical examples of tolyltriazole and benzotriazole derivatives are also described in EP 1 485 444. However, tolyltriazole, benzotriazole and their sodium salts are preferred.

Other additives that may be contained in the coolant or coolant concentrate are conventional dyes, denaturants, bittering agents (e.g., denatonium benzoate), hard water stabilizers (e.g., polyacrylic acid, polymaleic acid, acrylic acid/maleic acid copolymers and terpolymers, phosphonates or phosphinates), antifoam agents, wetting agents, and antioxidants. For hard water stabilizers applied specifically to phosphate containing coolants see patent PCT/US2019/044185 and patents referenced therein.

The pH value of the concentrates of the invention is usually in the range of 5 to 9.5, preferably 5 to 9, and most preferably 7.5 to 8.5. The desired pH value can optionally also be achieved by addition of alkali metal hydroxide, ammonia, or amines. Solid sodium or potassium hydroxide and aqueous caustic soda or potassium hydroxide solutions are most suitable for coolants with standard electrical conductivity. For low conductivity coolants with an electric conductivity <250 μS/cm trialkylamines, wherein the alkyl groups can independently of each other contain 1 to 6, preferably 1 to 3 carbon atoms, or trialkanolamines, wherein the alkanol groups independently of each other may contain 2 to 6, preferably 2 or 3 carbon atoms are especially preferred.

In a preferred embodiment of the invention, the coolant concentrate includes more than 90 weight percent with respect to the total amount of the concentrate of at least one freezing point lowering liquid, 1.0 to 5.0 weight percent with respect to the total amount of the concentrate of at least one saturated aliphatic or cycloaliphatic dicarboxylic acid, or mixture thereof, 0.1 to 2.5 weight percent with respect to the total amount of the concentrate of at least one saturated aliphatic- or aromatic mono-carboxylic acid or an aromatic di- or tri-carboxylic acid, or mixture thereof, 0.05 to 0.5 weight percent with respect to the total amount of the concentrate of at least one azole, 0.02 to 0.5 weight percent with respect to the total amount of the concentrate of at least one alkali metal or earth alkali metal nitrate, phosphate, molybdate, or mixture thereof, 0.05 to 0.6 weight percent with respect to the total amount of the concentrate of at least one stabilized silicate.

The Silicon content as SiO₂ of the coolant concentrate is in weight proportions from 100 ppm to 1000 ppm, preferably from 200 ppm to 800 ppm, most preferably from 300 ppm to 600 ppm. The silicate is stabilized with an organic silane of the general formula (I):

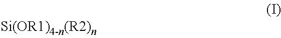

where
R1 is an organic radical linked to the oxygen atom by a carbon-oxygen bond, a hydrogen atom, or an alkaline metal,
n is an integer or fraction ranging from 1 to 3, and
R2 is an organic radical linked to the silicon atom by a silicon-carbon bond.

In an exemplary embodiment, siloxane-based Si-stabilizers comprise SILQUEST AF-1 or Dynasylan 4148 (polyalkyleneoxide-alkoxysilane), SILQUEST A-186 (2-(3,4-epoxycyclohexyl)-ethyltrimethoxysilane), SILQUEST A-187 (3-glycidoxy propyltrimethoxy silane), or other SILQUEST organosilane compounds available from MOMENTIVE and other suppliers. Other non-limiting examples of organosilane compounds for use herein include 3-aminopropyltriethoxysilane, N-2-(aminoethyl)-3-aminopropyltrimethoxysilane, octyltriethoxysilane, vinyltriethoxysilane, vinyltrimethoxysilane, methyltriethoxysilane, 3-methacryloxypropyltrimethoxysilane, 3-mercaptopropyltrimethoxysilane, isobutyl trimethoxysilane, phenyltrimethoxysilane, methyltrimethoxysilane, and those organosilane compounds having a structure similar to the foregoing, but with differing numbers of carbon atoms.

Furthermore, the objects of the present invention are achieved using the coolant concentrate, as a heat transfer fluid, for the cooling of an internal combustion engine, and for the cooling of a Battery Electric Vehicles (BEV) or fuel cell vehicle. Due to the flux resistance of the coolant concentrate, it is particularly suitable for the use in radiators or cooling systems of internal combustion engines, for example of motor vehicles and trucks, BEVs, and general heat transfer systems (e.g., HVAC, heat pumps) made with aluminum and aluminum alloys.

### DESCRIPTION OF THE FIGURES

FIG. 1 shows a plot of 50:50 ready-mix coolant based on MEG (mono-ethylene glycol) and DI-water.

### DETAILED DESCRIPTION OF THE INVENTION

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide coolant formulae for use in flux contaminated cooling components.

Hereinafter, the invention will be described in greater detail by means of examples. A silicon-containing, nitrite- and borate-free coolant concentrate for combustion engines is described here, based on a mixture of carboxylic acids, azoles, alkylene glycols, and their derivatives. Silicate provides excellent corrosion protection, particularly for aluminum and its alloys. Thus, in silicate-containing coolants, it is to be prevented that a reduction of the silicate or silicon content occurs, since otherwise the corrosion protection is affected. The described coolant concentrate has an increased thermal stability and an increased compatibility towards flux residues.

Comparative Test: Flux storage tests were performed with various organic silicate stabilizers (silanes) such as:
sodium-(trihydroxysilyl) propymethylphosphonate (A) known as Xiameter® Q1-6083;
2-[Methoxy (polyethyleneoxy) propyl]trimethoxysilane (B) known as Silan AF-1 or Dynasylan® 4148;
3-(Triethoxysilyl) propylsuccinic anhydride (C) known as Geniosil® GF-20; and
3-(Trihydroxysilyl) propane-1-sulfonic acid (D).

Silicate stabilizer D is an experimental reagent and to our knowledge not known to be used in commercial coolants. In each case, 20 ml of coolant were mixed with 20 ml of deionized (DI) water in a 100 ml polyethylene (PE) bottle with screw cap and the initial Si-content was determined by Inductively Coupled Plasma Mass Spectrometry (ICP-MS). To this mixture 60 mg of NOCOLOK® Flux was added (1500 ppm), and the mixture was mixed by shaking, and, subsequently, the coolant mixture was heated and stored at 90° C. for 72 hours. Once the coolant reached room temperature again, 5 ml of each mixture was filtrated through a 0.45 μm filter and the silicon content was again determined by ICP-MS. The following Table 1 shows representative examples for the coolant compositions as well as the decrease in the silicate content in percent over the test period of 72 hours.

TABLE 1
Flux-stability of different Si-stabilizer in Si-OAT formulations

| | Coolant 1 | Coolant 2 | Coolant 3 | Coolant 4 | Coolant 5 |
|---|---|---|---|---|---|
| | (inorganic | (inorganic | (inorganic | (inorganic | (organic |
| Component | Si) | Si) | Si) | Si) | Si) |
| Carboxylic Acid | 3.9 | 3.9 | 3.9 | 3.9 | 2.0 |
| 1 [%] | | | | | |
| Carboxylic Acid | 0.15 | 0.15 | 0.15 | 0.15 | 0 |
| 2 [%] | | | | | |
| Carboxylic Acid | 0 | 0 | 0 | 0 | 1.6 |
| 3 [%] | | | | | |
| Silicate stabilizer | A | B | C | D | B |
| Azole (1 + 2) [%] | 0.2 | 0.2 | 0.2 | 0.2 | 0.2 |
| Silicon content | 133 | 132 | 135 | 120 | 111 |
| (ppm start) | | | | | |
| Silicon content | 28 | 94 | 27 | 14 | 74 |
| (ppm end) | | | | | |
| Si [%] | 0.21 | 0.71 | 0.20 | 0.12 | 0.67 |

All coolants shown in the table contain the same concentration of carboxylic acids, the same concentration of azoles, and the same amount of stabilized silicate. The stabilized silicate amount was adjusted to contain 200 ppm inorganic Silicon as Si from a silicate source described above and 65 ppm organic silicon as Si which originated from the silicate stabilizer/silane in the coolant concentrate. Coolants 1 to 4 are inorganic silicate-containing coolants according to the present invention, while coolant 5 contains a stabilized non-ionic silicate. The coolant concentrates were prepared according to standard procedures described in U.S. Pat. Nos. 5,651,916, 4,333,843, and 4,629,602, and literature (technical data sheets) related to the specific silicate stabilizers used. The organosilane/silicate copolymers either may be formed in situ, during the production of the coolant antifreeze formulation, by reacting the alkali metal silicates present there with the organic silane compound of the coolant (I) in a Si (inorganic)/Si (organic) ratio from 1:1 to 10:1, preferably from 2:1 to 6:1, or can be prepared separately beforehand. In this case, an appropriate amount of the organic silane compound of the coolant (I) is added to the alkali metal silicate solution, and the mixture is stirred at from 20 to 60° C., preferably from 30 to 40° C., in water or a glycol/water mixture for 5 to 10 hours. The resulting organosilane/silicate copolymer, which contains about 20-90%, preferably 30-75% by weight of the sum of the two reactants (silane and silicate solution), can then be added to the antifreeze formulation containing the remaining components as a concentrated premix. The latter method is preferred. The pH of the coolant was adjusted to 8.5.

As can be seen in the table, the reduction of the silicate content in the coolant is significantly less in coolant 2 and 5 than in coolants 1,3, and 4, which do not contain a non-ionic silane as a silicate stabilizer such as 2-[Methoxy (polyethyleneoxy) propyl]trimethoxysilane. While coolant 1,3, and 4 form visual gelling, coolant 2 and 5 form a very fine precipitation which quickly settles to the bottom of the container after shaking. Silicate stability (without flux) is excellent and has been evaluated in hard water stability tests for all coolants with synthetic hard water according to DIN 51367 (3.58 mmol CaCl₂)/MgSO₄) and by active silica measurement with the Molybdenum Blue method. Coolant samples 2 and 5 show excellent corrosion performance according to ASTM D1384 and ASTM D4340 standards. ASTM Glassware Corrosion data is also supported by electrochemistry data. Coolant sample 5 was prepared with an organic silicate ester of the type Si(OR)₄, specifically for this case with Si(OEt)₄, and can be referred to as a stabilized non-ionic silicate package. Alkoxyalkylsilanes, preferably triethoxymethylsilane, diethoxydimethylsilane, ethoxytrimethylsilane, trimethoxymethylsilane, dimethoxydimethylsilane and methoxytrimethylsilane can also be used. Preference is given to tetraalkoxysilanes; particularly preferably are tetramethoxysilane and tetraethoxysilane with tetraethoxysilane being the most preferrable. The organosilane/silicate copolymers in the stabilized non-ionic silicate package were prepared beforehand and then added to the Si-free base coolant formula as a concentrated premix. The non-ionic silicate package was prepared by adding an appropriate amount of the organic silane silicate stabilizer to a solution of an orthosilicate ester in water or water/glycol containing a catalyst and wetting agent. The stabilized non-ionic silicate package has a conductivity of <20 μS/cm. Not bound to theory, a non-ionic silane as silicate stabilizer appears to prevent gelling by steric stabilization instead of electrostatic stabilization allowing the flux to remain insoluble or dispersing the flux in the coolant solution without “reacting” with the silicon material.

Because a stabilized non-ionic silicate package has no advantage in a regular, high conductivity coolant having a conductivity range from 3000 to 5000 μS/cm, we explored the stabilized non-ionic silicate in low conductivity BEV and FC coolants having a conductivity range of 0-200 μS/cm. “Silicates” are known to boost corrosion performance, especially for aluminum which is a metal widely used in BEV- and FC-cooling systems, and therefore, a stabilized non-ionic silicate will improve corrosion performance in a low conductivity coolant (<200 μS/cm) without having any impact on the conductivity. The stabilized non-ionic silicate was applied to a known phosphate/amine technology for low conductivity coolants published in PCT/EP/2002/002489, JP 7017612 B1, and U.S. Pat. No. 7,344,655 B1. These publications do not reference Si-corrosion inhibitors of any kind. Formulations were prepared according to the published technology referenced above and the Si-content was adjusted to 100 ppm Silicate (as Si) in the 50:50 ready-mix based on mono-ethylene glycol and DI-water for each formulation. Formulations with different phosphate and amine concentrations (formulations 1-6), while keeping the phosphate/amine ratio constant, were prepared and the conductivity and the reserve alkalinity (RA) measured. The amine concentration ranges from 0.1% to 1.0% and the phosphate concentration ranges from 0.0025% to 0.025% in increment steps from formulation 1 to 6 in table 2. Triethanolamine (TEA) was used to neutralize the phosphoric acid and to adjust the pH value to 8.5 in all formulations. Formulation 3, for example, contains 0.25% TEA and 0.007% Phosphoric acid by weight. All formulations contain benzo- and tolyltriazole as yellow metal corrosion inhibitors.

TABLE 2
Low-conductivity coolant based on phosphate
and amine with stabilized non-ionic silicate

| Formulation | 1 | 2 | 3 | 4 | 5 | 6 |
|---|---|---|---|---|---|---|
| Conductivity | 18.1 | 33.5 | 41.0 | 51.9 | 108.6 | 141.3 |
| [uS/cm] | | | | | | |
| RA | 0.76 | 1.4 | 1.8 | 2.2 | 5.3 | 7.1 |

No silicon depletion was observed when the formulations in the Table 2 were tested according to the above-mentioned flux test conditions. While standard ICE-coolants in Table 1 afford maximum 70-80% of original Si-content after the flux test, phosphate-based low conductivity formulas with the stabilized non-ionic silicate retain 100% of the original silicon (Si) within the measurement error. Formulation 3 shows excellent corrosion performance according to modified ASTM D1384 and ASTM D4340 standards for low conductivity coolants. ASTM Glassware Corrosion data is also supported by electrochemistry data. It is evident from Table 2 that an amine-phosphate inhibitor technology with a stabilized non-ionic silicate can afford a low conductivity coolant (<200 μS/cm) with a RA of a standard ICE-coolant, see formulation 5 and 6 in Table 2. A high reserve alkalinity (RA) provides longevity and an extended coolant life. It should be apparent to a skilled person in this field that the stabilized non-ionic silicate can be used to formulate low conductivity coolants (<200 μS/cm) based on an OAT-technology (Organic Acid Technology) comprising ammonium, alkali-, or earth alkali metal salts of aliphatic-, cycloaliphatic- or aromatic mono-, di, or tri-carboxylic acids to boost their corrosion performance while achieving excellent flux stability with no silicon depletion. Publication EP 3960834 A1 describes a stabilized silicate in a low conductivity BEV coolant, nevertheless, a drop of alkalinity and especially silicon content is observed after the corrosion test.

It was observed that a phosphate-amine inhibitor combination is superior to a carboxylic acid-amine inhibitor combination due to phosphoric acid's three very different and favorable pKa-values (pKa1=2.2, pKa2=7.2, pKa3=12.3), and therefore, more ideal buffering capability compared to an aliphatic- or aromatic monocarboxylic acids' buffering capability. Aliphatic- or aromatic monocarboxylic acids have a pKa-value in the range of 4-5.5, and therefore, below the ideal coolant pH of 7-8.5. The pKa-value of the amine component is also important. As triethanolamine's pKa-value is 7.7, TEA is an ideal pH-buffering component for low conductivity coolants.

Due to the ionic character, which causes high conductivity, of most corrosion inhibitors like alkali- and earth alkali metal salts of aliphatic- and aromatic acids and inorganic corrosion inhibitors like phosphate and nitrate, their concentration in low conductivity coolants is severely limited. A limited concentration of corrosion inhibitors has a negative impact on corrosion performance and reserve alkalinity, and therefore, longevity of the coolant. Compared to a high conductivity standard ICE-coolant, these performance factors can be seen as a disadvantage of low conductivity BEV-coolants at the current state of technology.

As conductivity is correlated with “ion-mobility” the polarity of the glycol will influence the conductivity. Coolant formulations with a glycol less polar than monoethylene glycol will therefore have a lower conductivity. This can be clearly demonstrated with 1,4-butandiol, a less polar glycol compared to monoethylene glycol, as an antifreeze component instead of monoethylene glycol. For illustration purposes formulation 3 was chosen from Table 2 and the monoethylene glycol portion of the 50:50 ready-mix was stepwise replaced with 1,4-butandiol, see Table 3. When monoethylene glycol is fully replaced by 1,4-butandiol the conductivity decreases by about 60%. Other glycols like 1,2 propandiol, 1,3-propandiol, di- and triethylene glycol, and low molecular-weight (<2000 g/mol) polyoxyethylene glycols were also evaluated, nevertheless, the largest impact was observed with 1,4-butandiol.

TABLE 3
Conductivity vs. 1,4-butandiol concentration
shown on Formulation 3 from Table 2.

| 1,4-Butanediol | Conductivity | | |
|---|---|---|---|
| [%] | [μS/cm] | pH | RA [mL] |
| 0 | 37.99 | 8.75 | 1.8 |
| 25 | 25.97 | 8.71 | 1.8 |
| 50 | 16.15 | 8.74 | 1.8 |

When 1,4-butandiol is used instead of monoethylene glycol the inhibitor concentration can be increased two- to three-fold while achieving the same conductivity. A two- to three-fold increase in corrosion inhibitor concentration achieves improved corrosion performance and extended longevity. In comparison to monoethylene glycol the physical parameters like boiling point, freezing point, and viscosity are only slightly affected. The conductivity lowering properties of less polar freezing point lowering liquid can be transferred to other formulations and is not limited to low conductivity coolants. While monoethylene glycol's oxidation product are formic- and oxalic acid, 1,4-butandiol's oxidation product is succinic acid. Succinic acid is less aggressive and less corrosive than formic-, oxalic- and glycolic acid. For BEV and FC applications these features of 1,4-butandiol, together with its electrical conductivity lowering properties, can be advantageous over monoethylene glycol as a freeze point lowering liquid. Mixture of monoethylene glycol with diethylene glycol, triethylene glycol, or polyalkylene glycol polymers with the general formula H—(OCH₂CHR)ₙ—OH, wherein R=methyl or hydrogen or mixtures thereof and wherein n=2 to 200 also have the ability to decrease the electrical conductivity of coolants. Diethylene glycol, triethylene glycol and polyalkylene glycol polymers are also less prone to oxidation than monoethylene glycol, and mixture thereof with monoethylene glycol can be advantageous for low conductivity applications to allow a stable and low conductivity over time of operation. Representative polyalkylene glycols include but are not limited to polyethylene glycols, polypropylene glycols, and combinations thereof. Representative polyethylene glycols include but are not limited to CARBOWAX™ polyethylene glycols from DOW Chemical Company (e.g., CARBOWAX PEG 200, 300, 400, 600, 1000, 1450, 3350, 4000 & 8000 etc.) or PLURACOL® Polyethylene glycols from BASF Corporation (e.g., Pluracol® E200, 300, 400, 600, 1000, 2000, 3350, 4000, 6000 and 8000, etc.). Representative copolymers of ethylene oxide (EO) and propylene oxide (PO) include but are not limited to various PLURONIC and PLURONIC R block copolymer surfactants from BASF, DOWFAX non-ionic surfactants, UCON™ fluids and SYNALOX lubricants from DOW Chemical.

It is known that inorganic silicate is less stable in less polar glycols, e.g., monoethylene glycol vs. 1,2-propylene glycol, as described in U.S. Pat. No. 5,651,916. The stabilized non-ionic silicate's stability does not depend on the polarity of the glycol and is therefore an ideal candidate for a low conductivity coolant with different, less polar glycols. Excellent corrosion and silicate stabilization was confirmed by ASTM D1384 and ASTM D4340 glassware tests. There is a possibility that the stabilized non-ionic silicate functions with an additional or different corrosion protection mechanism compared to a regular stabilized inorganic silicate. Not bound to theory, besides forming a protective silicate layer on the inner metal surface, the stabilized non-ionic silicate can possibly adsorb on the surface as do organic acids.

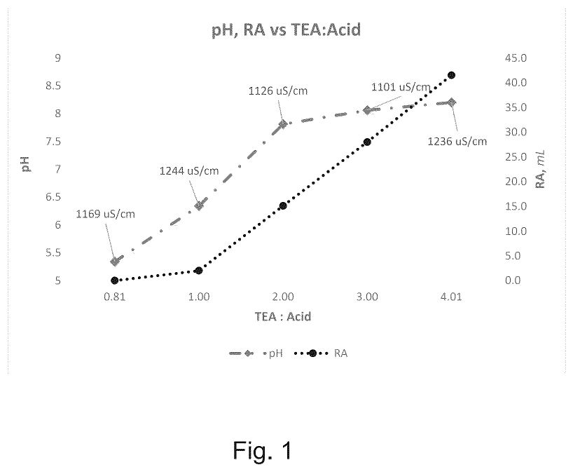

During studies on low conductivity BEV coolants based on a phosphate-amine inhibitor corrosion package it was noticed that the conductivity correlates linearly with the concentration of permanent ionic species, such as alkali- and earth alkali metal salts of carboxylic acids or phosphate and nitrate and is less dependent on the amount of amine present, in this specific case triethanolamine (TEA). Surprisingly, the conductivity and pH of an amine-based coolant formulation reaches a plateau while the RA still increases linearly when a specific amine/permanent ionic corrosion inhibitor ratio is reached, see FIG. 1. For illustration purposes a commercial coolant formula (50:50 ready mix) was utilized where the alkali- and earth alkali metal cations were replaced by triethanolamine salts. This phenomenon is specific for amine-based coolants and cannot be realized with a standard coolant based on alkali- and alkaline earth metal salts of carboxylic acids or inorganic corrosion inhibitors like phosphate and nitrate. In standard ICE-coolants a higher RA correlates with a higher conductivity and in some cases even a higher pH-value.

In general, only the anionic species in a coolant are responsible for the corrosion and RA properties while the cationic species have no active function. Replacing cations like alkali- and alkaline earth metals, which show a high molecular conductivity, with an amine, which shows a lower molecular conductivity than alkali- and alkaline earth metal cations, TEA in this specific case, therefore affords a lower conductivity coolant with no impact on corrosion performance or other physical and chemical parameters. Additional RA and longevity, without any impact on the conductivity, can be achieved by increasing the amine/inhibitor molar-ratio above 2, see FIG. 1. A stabilized non-ionic silicate is especially suited for such low conductivity formulations because it adds additional corrosion protection without increasing the conductivity.

The “alkaline metal cation-amine replacement” was applied to known OAT-technology coolants published in, for example, PCT/US2019/044185 and US 2014/0224193 A1. Table 4 shows commercial 50:50 ready-mix formulas where alkali- or alkaline earth metals were replaced with ammonium salts, TEA specifically. Table 4 clearly shows that a cation replacement can reduce the electrical conductivity by more than 50% while even increasing the RA.

TABLE 4
Alkaline metal cation replacement influence on conductivity
and reserve alkalinity with commercial formulas

| | Original | Modified | |
|---|---|---|---|
| Coolant | Conductivity | Conductivity | Reserve Alkalinity |
| Formulation | [μS/cm] | [μS/cm] | [ml 0.1M HCl] |
| 1 | 4000 | 2050 | 14.9 |
| 2 | 3800 | 1500 | 15.2 |
| 3 | 3900 | 1280 | 15.1 |
| 4 | 4200 | 1700 | 11.2 |

The following claims are thus to be understood to include what is specifically illustrated and described above, what is conceptually equivalent, what can be obviously substituted. Those skilled in the art will appreciate that various adaptations and modifications of the just-described preferred embodiment can be configured without departing from the scope of the invention. The illustrated embodiment has been set forth only for the purposes of example and that should not be taken as limiting the invention. Therefore, it is to be understood that, within the scope of the appended claims, the invention may be practiced other than as specifically described herein.

What is claimed is:

1. A coolant concentrate consisting essentially of:
at least one freezing point lowering liquid;
at least one saturated aliphatic- or aromatic mono-carboxylic acid, or at least one saturated aliphatic- or cycloaliphatic dicarboxylic acid or at least one aromatic di- or tri-carboxylic acid, or mixtures thereof;
at least one azole;
at least one alkali metal or alkaline earth metal nitrate, phosphate, or mixtures thereof; and
at least one silicate, stabilized by an organic silane.

2. The coolant concentrate of claim 1, wherein the freezing point lowering liquid is selected from the group consisting of alkylene glycol, alkylene glycol ether, glycol ether, glycerin and a mixtures thereof.

3. The coolant concentrate of claim 2, wherein the freezing point lowering liquid Is selected from the group consisting of monoethylene glycol, monopropylene glycol, 1,3-propandiol, 1,4-butandiol, glycerol, diethylene glycol, triethylene glycol and mixtures thereof.

4. The coolant concentrate of claim 1, wherein the aliphatic- and cycloaliphatic mono- and dicarboxylic acids have chain lengths between 4 and 12 carbon atoms.

5. The coolant concentrate of claim 1, wherein the dicarboxylic acids and/or the monocarboxylic acids are present in the form of their alkali or alkaline earth metal salts.

6. The coolant concentrate of claim 1 further comprising a pH-adjusting component.

7. The coolant concentrate of claim 1, wherein the pH the concentrate is between pH 7 and pH 9.

8. The coolant concentrate of claim 1 including:
more than 90 weight percent of the at least one freezing point lowering liquid;
0.5 to 5.0 weight percent of the at least one saturated aliphatic- or aromatic mono-carboxylic acid, or the at least one saturated aliphatic- or cycloaliphatic dicarboxylic acid or the at least one aromatic di- or tri-carboxylic acid, or mixtures thereof;
0.05 to 0.5 weight percent of the at least one azole;
0.02 to 0.5 weight percent of the at least one alkali metal or alkaline earth metal nitrate, phosphate, molybdate, or mixture thereof; and
0.05 to 0.6 weight percent of at least one silicate stabilized by an organic silane.

9. The coolant concentrate of claim 1, wherein the concentration of silicon as SiO₂ is from 100 ppm to 1000 ppm.

10. The coolant concentrate of claim 9, wherein the concentration of silicon as SiO₂ is from 200 ppm to 800 ppm.

11. The coolant concentrate of claim 10, wherein the concentration of silicon as SiO₂ is from 300 ppm to 600 ppm.

12. The coolant concentrate of claim 1, characterized in that the organic silane has a general formula of Si(OR¹)₄₋ₙ (R²)ₙ where n is an integer or a fraction ranging from 1 to 3, R¹ is a first organic radical linked to oxygen by a carbon-oxygen bond, a hydrogen atom, or an alkali metal and R² is a second organic radical linked to silicon by a silicon-carbon bond.

13. The coolant concentrate of claim 12, wherein R¹ is a linear or branched alkyl radical having from 1 to 10 carbon atoms or a cyclic alkyl, aryl or an alkyl radical having from 6 to 14 carbon atoms.

14. The coolant concentrate of claim 12, wherein R² is a linear or branched alkyl radical having from 1 to 10 carbon atoms or a cyclic alkyl, aryl or an alkyl radical having from 6 to 14 carbon atoms, and can include a functional group with N, S or O heteroatoms.

15. The coolant concentrate of claim 14, wherein the functional group is an amino group or an epoxy group.

16. The coolant concentrate of claim 12, wherein R² has the formula CH₂CH₂CH₂—(OCHR₃CH₂)ₘ—OR⁴ where m is an integer or fraction between 1 and 20, R³ is a hydrogen atom or an alkyl radical and R⁴ is an alkyl radical having from 1 to 10 carbon atoms.

17. The coolant concentrate of claim 1, wherein the at least one silicate is replaced by an organic silane having a general formula of Si(OR)₄, or an organic disilazane of a general formula R₃SiNHSiR₃, or acetamides of a general formula SiR₃NH(C═O)R, or acetamides of a general formula R₃Si(N═CR)—OSIR₃ where R can be an alkyl-, or an aryl-group having between 1 and 36 carbon atoms, and where the at least one phosphate is phosphoric acid, pyrophosphoric acid, oligophosphoric acid, polyphosphoric acid, phosphonic acid, or organophosphorus compounds containing R²—PO(OH)₂ or PO(OH)ₙ(OR²)ₘ structures, where R² is an alkyl, hydroxyalkyl, or aryl-group and n/m is 1-3 and n+m is 3 and/or at least one ammonium, alkali-, or alkaline earth metal salt of an aliphatic-, cycloaliphatic, or aromatic mono-, di, or tri-carboxylic acid or mixtures thereof.

18. The coolant concentrate of claim 17, wherein the R groups of Si(OR)₄ are the same or different and are C1- to C20-alkyls, C2- to C20 alkenyls or C1- to C20-hydroxyalkyls.

19. The coolant concentrate of claim 17, wherein the R groups of Si(OR)₄ are substituted C6- to C12-aryl or a glycolether-residues of a general formula (CH₂—CH₂—O)ₙR^{D}, where R^{b} is hydrogen or C1- to C6-alkyl residues, and n is 1-5.

20. The coolant concentrate of claim 17, further containing at least one amine of a general structure NR₃ where R is an alkyl-, aryl-, or hydroxyalkyl group containing between 1 and 36 carbon atoms including trialkylamines, wherein the alkyl groups can independently of each other contain 1 to 6, or trialkanolamines, wherein the alkanol groups independently of each other contain 2 to 6 carbon atoms or amines of a general structure RN(—CH₂CH₂—OH)₂, where R can be an alkyl-, or an aryl-group containing between 1 and 36 carbon atoms or a cyclo-alkyl group wherein the cyclo-alkyl group contains 6 to 8 carbon atoms or diethanolamines wherein the alkyl group contains 4 to 10 carbon atoms.
